(19) United States
(12) Patent Application Publication
(10) Pub. No.: US 2010/0094554 A1
(43) Pub. Date: Apr. 15, 2010

(54) Systems and Methods for Accessing Data Over a Short-range Data Link to Enhance the Performance of a Navigational Unit

(75) Inventors: John Robert Orrell, JR., Advance, NC (US); Marquis D. Doyle, Louisville, NC (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/250,380

(22) Filed: Oct. 13, 2008

(51) Int. Cl. G01C 21/00

(52) U.S. Cl. 701/214; 701/207

(57) ABSTRACT

A method for accessing data from a secondary device to enhance position data of a navigation unit is described. A short-range data link is established between a navigation unit and a secondary device. Secondary time data is received from the secondary device over the short-range data link. Secondary position data is received from the secondary device over the short-range data link.

### BACKGROUND

1. Field

The present systems and methods relate generally to wireless devices, and more specifically to systems and methods for accessing data over a short-range data link to enhance the performance of a navigational unit.

2. Background

Many wireless communications devices, such as mobile phones, pagers, handheld computers, etc., have the ability to determine the location parameters associated with the geographical position of a wireless device. The location parameters may include the position coordinates for the wireless device. The wireless device may include a geographical position location system in the form of hardware, software and/or firmware and other associated parameters.

Location data may be received from several systems. One example may be the Global Positioning System (GPS). The GPS is a radio-navigation system that includes a series of 24 constellation satellites orbiting the earth at a distance of approximately 20,000 kilometers. The GPS data allow device processors to determine their respective positions using position data and timing data received from the satellites. The GPS is but one example of a satellite positioning system (SPS). Other SPSs include, for example, Global Navigation Satellite Systems (GNSS), Galileo positioning system (Europe), Glonass (Russian), Compass/Beidou (Chinese), and QZSS (Japanese) to name but a few. Moreover, instead of using SPSs, location data may be determined from terrestrial based systems or a combination of satellite and terrestrial systems, also known as hybrid systems.

Determination of wireless device geographical location may not be limited to GPS. For example, wireless devices may use a type of assisted GPS (AGPS), where the GPS location data is combined with additional information related to the wireless network, such as position information from wireless network base stations, to increase the accuracy of the position location information.

In some instances, a GPS enabled device may not be able to receive signals from the satellites. For example, the GPS device may be positioned in a location that does not receive GPS signals, such as, a building, canyon, or the like. In still other instances, an obstacle may block the satellite signals from reaching the device. Further, significant time may be required when the GPS device is powered up to perform a scan in order to locate a satellite signal.

In some cases, when the GPS enabled device cannot acquire a satellite signal, the GPS enabled device may try to acquire a signal from, for example, a wireless network base station as part of the AGPS system. However, the GPS enabled device may not be able to receive location data from a stationary AGPS device (such as a base station, server, etc.) either. For example, physical obstructions (e.g., buildings, canyons, distance, etc) may inhibit a reliable data link between the GPS enabled device and the stationary AGPS device. As a result, benefits may be realized by providing systems and methods to access location data over a reliable data link. In particular, benefits may be realized by providing systems and methods for accessing data over a short-range data link to enhance the performance of a navigational unit, such as a GPS device.

### SUMMARY

A method for accessing data from a secondary device to enhance position data of a navigation unit is described. A short-range data link is established between a navigation unit and a secondary device. Secondary time data is received from the secondary device over the short-range data link. Secondary position data is received from the secondary device over the short-range data link.

A navigation unit that is configured to access data from a secondary device to enhance position data of the navigation unit is also described. The navigation unit includes a receiver configured to establish a short-range data link with a secondary device. The receiver is further configured to receive secondary time data from the secondary device over a short-range data link. The receiver is further configured to receive secondary position data from the secondary device over the short-range data link.

An apparatus that is configured to access data from a secondary device to enhance position data of the apparatus is also described. The apparatus includes means for establishing a short-range data link with a secondary device and means for receiving secondary time data from the secondary device over the short-range data link. The apparatus further includes means for receiving secondary position data from the secondary device over the short-range data link.

A computer-program product for accessing data from a secondary device to enhance position data of a navigation unit is also described. The computer-program product comprising a computer readable medium having instructions thereon. The instructions including code for establishing a short-range data link with a secondary device and code for receiving secondary time data from the secondary device over the short-range data link. The instructions further comprising code for receiving secondary position data from the secondary device over the short-range data link.

### BRIEF DESCRIPTION OF THE DRAWINGS

FIG. 1 is a block diagram illustrating one configuration of a secondary device in communication with a navigation unit;

FIG. 2 is a block diagram illustrating one configuration of a mobile station communicating with a navigation unit;

FIG. 3 is a block diagram illustrating one example of a mobile station receiving secondary time data and secondary position data over a network;

FIG. 4 is a block diagram illustrating one configuration of a server receiving data from a satellite;

FIG. 5 is a flow diagram illustrating one example of a method for receiving secondary time data, secondary position data, and transmitting the secondary data to a navigation unit;

FIG. 6 is a flow diagram illustrating one example of a method for accessing secondary time data and secondary position data from a secondary source in order to acquire a satellite signal;

FIG. 7 is a flow diagram illustrating one configuration of a method for using secondary data relating to position and time when the actual position data and time data are unavailable; and

FIG. 8 illustrates various components that may be utilized in a wireless device in accordance with the present systems and methods.

### DETAILED DESCRIPTION

Navigational units have become popular in commerce today in part because of the availability of accurate electronic maps. An example of a navigational unit may be a satellite position system device, of which a Global Positioning System (GPS) device is one example. The description herein uses GPS interchangeably with other SPSs. Navigational units, such as the GPS device, may determine the position of the user anywhere on earth with accuracies that range from tens of meters using autonomous low-cost receivers to the centimeter level using survey-grade receivers which operate in connection with a base station. In both of these modes of operation, the receiver may acquire and track signals from a plurality of satellites in order to make measurements of the distances from the receiver to each of the satellites in view.

The ability of the receiver to perform these tasks is often limited by the presence of buildings, mountains, foliage, or other obstacles that block or severely attenuate the received satellite signals. Further, even when no obstacles exist to prevent the navigational unit from receiving satellite signals, a considerable length of time may be necessary to search for and acquire the satellite signals when powering up the navigational unit. For example, a user may power down a navigational unit in a first location and then travel to a second location. Upon powering up the navigational unit in the second location, a considerable amount of time may be necessary for the navigational unit to search for and acquire satellite signals in the second location, read and interpret the position data included in said signals, and make the measurements needed to establish the position of the navigational unit.

In recent years, efforts have been made to overcome the limitations of weak signal reception (due to, for example, obstacles that block satellite signals among other reasons) and to reduce the time from navigational unit power up to the determination of the position of the navigational unit. The primary method of past systems is to use assisted positioning, in which an assistance server, located in a good satellite signal reception location, collects data from the satellites and transmits it, and other data, to the navigational unit via an independent communication link between the server and the navigational unit. However, die independent communication link between the assistance server and the navigational unit may not be reliable. For example, the navigational unit may be out-of-range of the assistance server. Another method of past systems uses inertial measurement transducers to fill in missing position data during times that the signal from the satellite is not available to the navigational unit. However, data supplied by inertial measurement transducers may not provide the most accurate position and location of the navigational unit. As such, benefits may be realized by providing systems and methods for accessing position and time information from a secondary source over a reliable link. In particular, benefits may be realized by providing systems and methods for accessing time data and position data from a mobile station over a short-range data link in order to enhance position data corresponding to the navigational unit, and to decrease the amount of time necessary to acquire a satellite signal during the power up phase of the navigational unit.

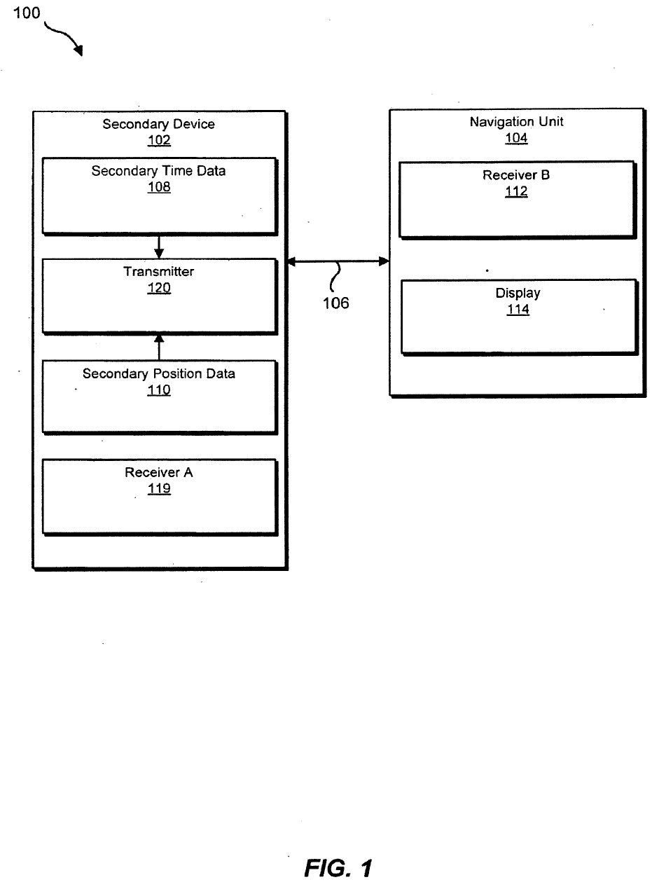

FIG. 1 is a block diagram illustrating one configuration 100 of a secondary device 102 in communication with a navigation unit 104. In one example, the secondary device 102 and the navigation unit 104 communicate via a short-range data link 106. The secondary device 102 may be a mobile device such as a cell phone, a smart phone, a personal digital assistant (PDA), a mobile station, user equipment, an access terminal, or any other type of wireless communications device. In one configuration, the secondary device 102 is part of a cellular network.

The secondary device 102 may include receiver A 119. Receiver A 119 may receive secondary time data 108 and secondary position data 110 over the cellular network. The secondary time data 108 may indicate the time-of-day. In one example, the secondary time data 108 is synchronized to the coordinated universal time (UTC). The secondary position data 110 may indicate a broad geographical area in which the secondary device 102 is located (i.e., region, state, city, etc.).

In one example, the navigation unit 104 includes receiver B 112. Receiver B 112 may receive the secondary time data 108 and the secondary position data 110 from the secondary device 102. For example, the secondary device 102 may include a transmitter 120 that transmits the secondary time data 108 and the secondary position data 110 to the navigation unit 104. In one configuration, the device 102 transmits the secondary data 108, 110 to receiver B 112 over the short-range data link 106. The short-range data link 106 may be implemented by one of several short-range communication technologies. For example, Bluetooth technology may be used to implement the short-range data link 106 between the device 102 and the navigation unit 104. The data link 106 may be based upon other types of short-range communication technologies including low power wireless technologies, such as infrared (generally known as IRDA, Infrared Data Association), Zigbee, Ultra Wide Band (UWB), and wired technologies, such as, universal serial bus (USB) connections, FireWire, computer buses, or other serial connections. If Bluetooth technology is used to establish the data link 106, a custom Bluetooth profile may be developed to support the transmission of the secondary data 108, 110 to the navigation unit 104.

In one configuration, the navigation unit 104 further includes a display 114. The display 114 may be a liquid crystal display (LCD). In one example, a user may access the display 114 to view the secondary data 108, 110 transmitted from the device 102.

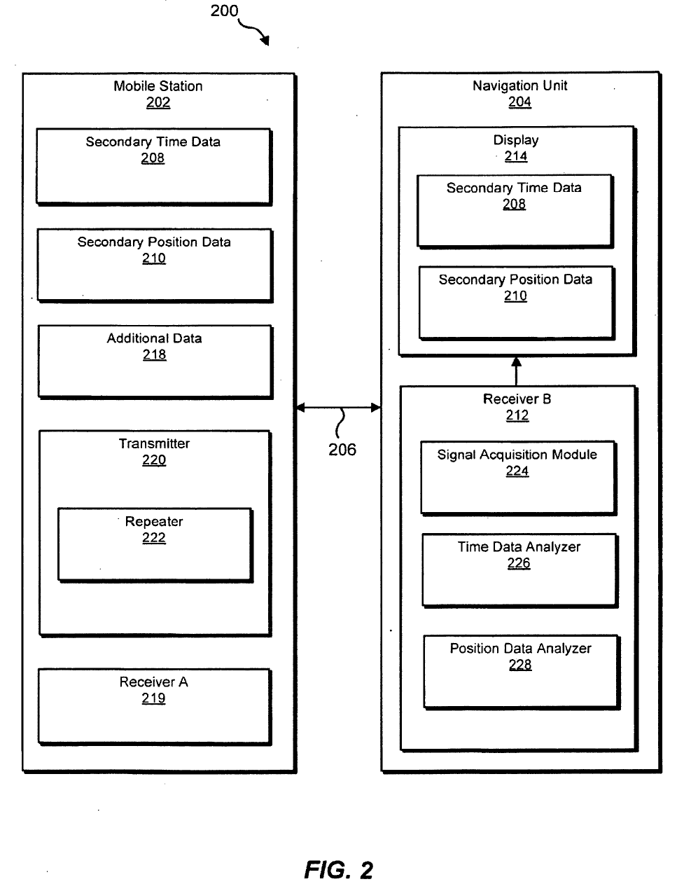

FIG. 2 is a block diagram illustrating one configuration 200 of where the secondary device is a mobile station 202 communicating with a navigation unit 204. As previously explained, the mobile station 202 and the navigation unit 204 may communicate over a short-range data link 206. The short-range data link 206 may be a Bluetooth link. The mobile station 202 may include secondary time data 208, secondary position data 210, and additional data 218. The secondary time data 208 may indicate the time-of-day according to the UTC and the secondary position data 210 may provide location information for the mobile station 202.

In one configuration, the additional data 218 includes ephemeris data. Ephemeris data may indicate the positions of astronomical objects in the sky at a given time or times. Further, ephemeris data may be a set of parameters that can be used to accurately calculate the location of a satellite at a particular point in time. The ephemeris data may describe the path that the satellite is following as it orbits the earth.

In another configuration, the additional data 218 may be almanac data. Almanac data may be used to predict which satellites are nearby when the mobile station 202 scans for a satellite signal. Almanac data may include a set of parameters for each satellite that can be used to calculate its approximate location in orbit.

The mobile station 202 also may include a transmitter 220. The transmitter 220 may include a repeater 222 that allows the transmitter 220 to repeat the transmission of data 208, 210, 218 across the short-range data link 206 to the navigation unit 204. The repetition may be constant or intermittent.

The navigation unit 204 may include receiver B 212. In one configuration, receiver B 212 includes a signal acquisition module 224, a time data analyzer 226, and a position data analyzer 228. Receiver B 212 may receive the secondary time data 208, the secondary position data 210, and the additional data 218 from the mobile station 202. In one aspect, the signal acquisition module 224 uses the secondary time data 208 to align receiver B 212 with one or more satellites orbiting the earth. For example, during the power up phase of the navigation unit, the signal acquisition module 224 may access the secondary time data 208 from the mobile station 202 across the short-range data link 206. The signal acquisition module 224 may use the secondary time data 208 to more quickly align receiver B 212 with one or more GPS satellites in order for receiver B 212 to receive satellite signals. In one example, the secondary time data 208 is the time data for a cellular network. Without accessing the secondary time data 208 across the short-range data link 206, the time to align receiver B 212 with a satellite significantly increases during the power up phase of the navigation unit 204.

In one example, receiver B 212 calculates the distance to a GPS satellite by determining the length of time that expired for a satellite signal to reach receiver B. In order to determine the time required for a satellite signal to reach receiver B, receiver B and the satellite include clocks that are synchronized. Receiver B may synchronize the secondary time data 208 to an atomic clock on the satellite. After synchronization to the satellite clock, receiver B 212 may be aligned with a satellite.

In one configuration, receiver B 212 further includes a position data analyzer 228. The position data analyzer 228 reads, interprets, and analyzes the secondary position data 210 to determine the location information provided by the secondary position data 210. In one example, the secondary position data 210 and the secondary time data 208 may be displayed via a display 214 on the navigation unit 204.

During the power up phase of the navigation unit 204, time data and position data acquired from satellite signals may not be available. As previously explained, a receiver within the navigation unit 204 takes time to align itself with a satellite during the power up phase. In addition, after the navigation unit 204 is powered up, obstacles may prevent the receiver within the navigation unit 204 from receiving satellite signals. In one configuration, a user may view the secondary time data 208 and the secondary position data 210 via the display 214 until time data and position data acquired from satellite signals is received.

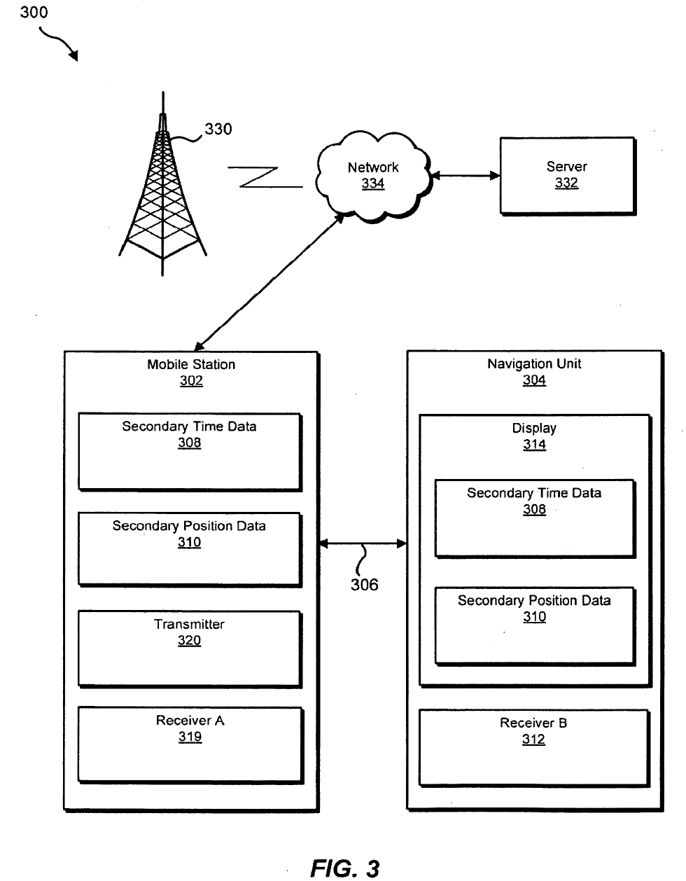

FIG. 3 is a block diagram illustrating one example 300 of a mobile station 302 receiving secondary time data 308 and secondary position data 310 over a network 334. In one aspect, the network 334 may be a cellular network. In addition, the network 334 may be any available network, such as, for example, a Worldwide Interoperability for Microwave Access (WiMAX) network, a Wireless Wide-Area Network (WWAN), a frequency modulation (FM) network (i.e., digital FM radio signals), etc.

In one configuration, the mobile station 302 may be connected to a base station 330, such as a cell tower. A server 332 may determine the position of the mobile station 302 based on which base station the mobile station 302 is connected to on the network 334. In one aspect, the server 332 provides secondary position data 310 and secondary time data 308 to the mobile station 302 over the network 334. As previously explained, receiver A 319 receives the secondary time data 308 and the secondary position data 310 from the server 332, and a transmitter 320 transmits the secondary data 308, 310 to a navigation unit 304. The secondary data 308, 310 may be transmitted to the navigation unit 304 via a short-range data link 306. Receiver B 312 may receive the secondary data 308, 310. In one configuration, a display 314 may display the secondary data 308, 310 to a user during the time that the reception of satellite signals is unavailable to the navigation unit 304.

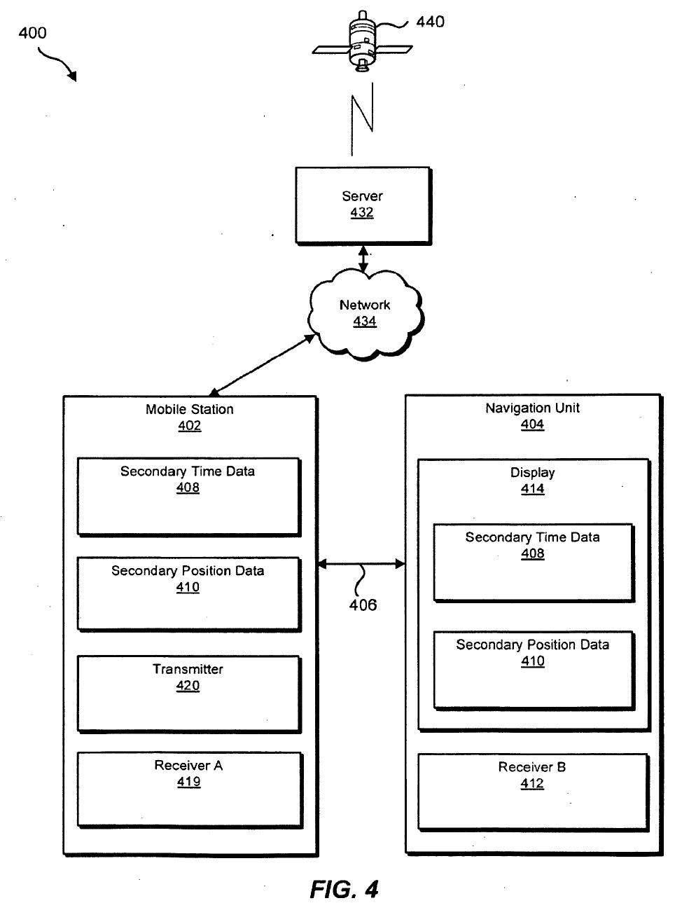

FIG. 4 is a block diagram illustrating one configuration of a server 432 determining the location of a mobile station 402. In one configuration, the block diagram illustrates one example of assisted-GPS (AGPS) technology. AGPS may be used to locate mobile stations in a wireless network. An AGPS server (such as the server 432) may provide data to the mobile station 402 that is specific to an approximate location of the mobile station 402. The server 432 may receive signals from a satellite 440 as well as signals from the mobile station 402. The server 432 may then compare the signals received from the satellite 440 with the signals received from the mobile station 402 and calculate the approximate location of the mobile station 402. The server 432 may transmit data (such as secondary time data and secondary position data) to the mobile device 402. The secondary data 408, 410 may be transmitted from the server 432 to the mobile station 402 across the network 434. As previously mentioned, the network 434 may include a cellular network. In an alternative configuration, the mobile station 402 may receive signals directly from the satellite 440 in order to determine an approximate location based on the received signals.

The secondary time data 408 and the secondary position data 410 may be further transmitted to the navigation unit 404 as previously described via a short-range data link 406, such as Bluetooth. A display 414 on the navigation unit 404 may display the received secondary time data 408 and secondary position data 410 to a user until a satellite signal is available to be received directly by the navigation unit 404.

In one configuration, once the navigation unit 404 acquires a satellite signal, primary time data and primary position data may be received at the navigation unit and displayed to a user. The primary data may be more accurate than the secondary data 408, 410 received from the mobile station 402. For example, secondary time data 408 may be synchronized to UTC while primary time data may be set to atomic clocks on a satellite. Primary time data may not be corrected to match the rotation of the earth, unlike secondary time data 408 that is set to UTC. In addition, secondary position data 410 may provide a broad geographical location (such as a region, state, territory, city, etc.) Primary position data received from a satellite may provide a more accurate location within a few feet and/or inches. In one configuration, the mobile station 402 may not be enabled to interpret detailed location information as provided by primary position data.

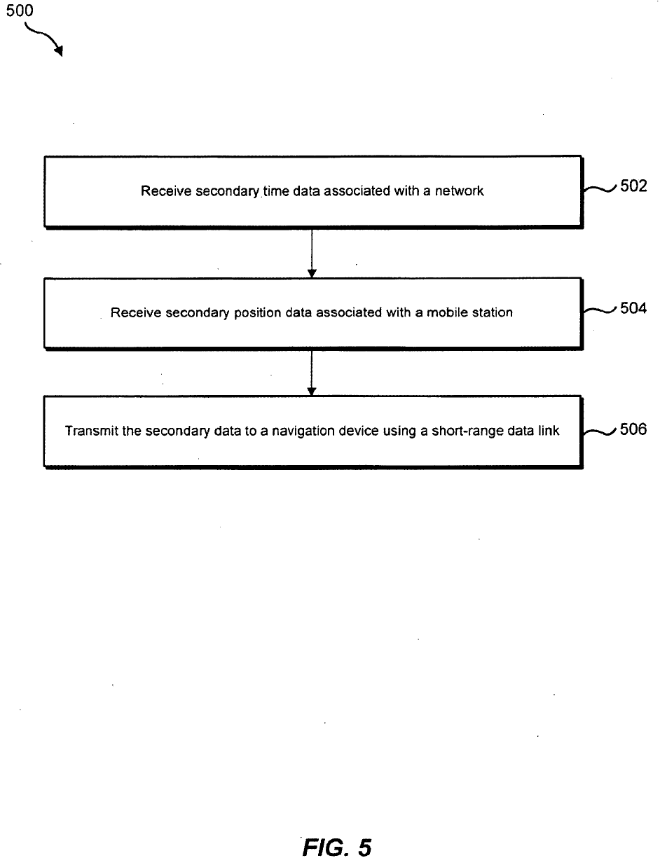

FIG. 5 is a flow diagram illustrating one example of a method 500 for receiving secondary time data, secondary position data, and transmitting the secondary data to a navigation unit. In one configuration, the method 500 is implemented by the mobile station 202. Secondary time data associated with the network may be received 502 by the mobile station 202 in this example. As described above, the network may be a cellular network, a WiMAX network, a WWAN, an FM radio network, etc. The secondary time data may be set to the correlated universal time (UTC) as mentioned previously.

In one configuration, secondary position data associated with a mobile device may be received 504 by the mobile station 202 in this example. The secondary position data may indicate an estimate of the location of the mobile station 202. For example, the secondary position data may indicate a general geographical area in which the mobile station 202 is located. Examples of geographical areas may include the name of a particular state, a city, a street name, etc. In one configuration, the secondary data may be transmitted 506 to a navigation device. The navigation device may be a GPS device. In one example, the data is transmitted 506 to the navigation device using a short-range data link.

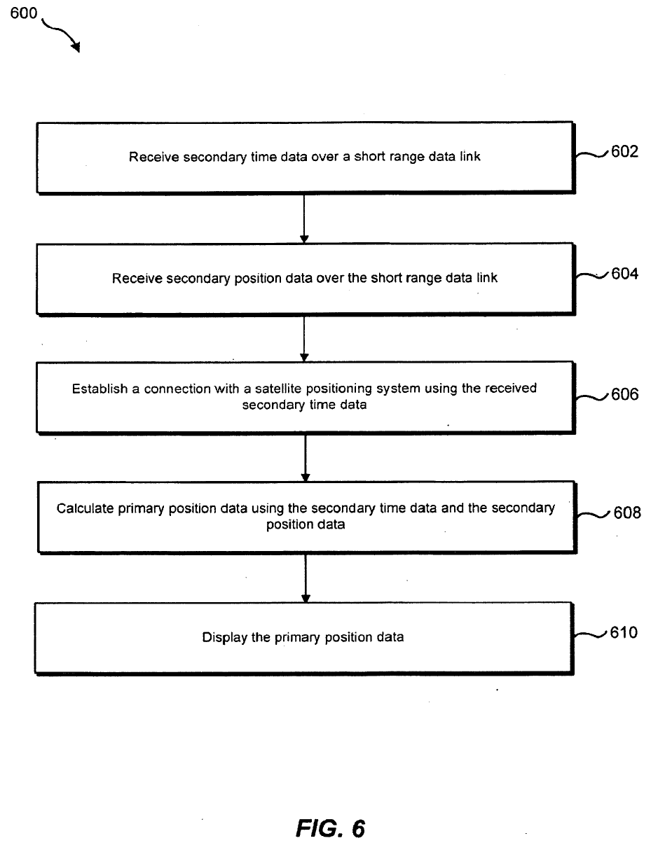

FIG. 6 is a flow diagram illustrating one example of a method 600 for accessing secondary time data and secondary position data from a secondary source in order to acquire a satellite signal. The operational steps provided herein are described in a particular order but the operational steps may be performed in the described order or other orders. Moreover, more, less, or other operational steps may be included that are not specifically described herein. In one configuration, the method 600 may be implemented by a navigation unit 104, such as a GPS device.

In one example, secondary time data may be received 602 over a short-range data link. As previously explained, the secondary time data may be the time associated with a cellular network. In addition, the short-range data link may be a Bluetooth link, a USB connection, a serial connection, etc. The secondary time data may be received 602 from a mobile station, such as cell phone, smart phone, PDA, etc.

In one example, secondary position data may be received 604 over the short-range data link. The secondary position data may be a broad geographical area in which the mobile station is located. In one configuration, a connection may be established 606 with a satellite positioning system, using the received secondary time data. In one configuration, a receiver may be aligned with a satellite device based on the secondary time data in order to establish 606 a connection with the satellite positioning system. In one example, the receiver receives a satellite signal once a connection is established 606.

In one configuration, primary position data may be calculated 608 using the secondary time data and the secondary position data. The primary position data may provide more information regarding a location than the secondary position data. For instance, primary position data may indicate geographical coordinates of the location of the navigation unit. In another example, the primary position data may include the name of a state, the name of a city, and longitude and latitude coordinates indicating the location of the navigation unit with a small degree of error (i.e., providing a location within a few feet, inches, etc. of the actual location).

In one configuration, the primary position data may be displayed 610. A user of the navigation unit may analyze the primary position data displayed on the navigation unit to determine his/her location. In another configuration, the secondary position data is displayed until the primary position data is calculated.

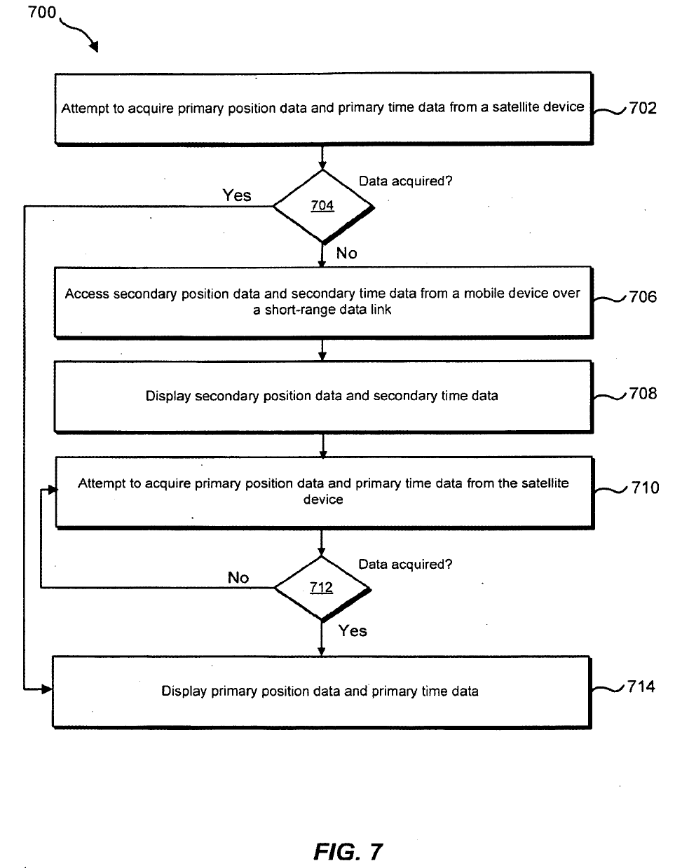

FIG. 7 is a flow diagram illustrating one example of a method 700 for using secondary data relating to position and time when the actual position data and time data are unavailable. The method 700 may be implemented by a navigation unit 104.

In one example, an acquisition of primary position data and primary time data from a satellite device is attempted 702. A determination 704 may be made as to whether the primary data was acquired from the satellite device. If it is determined 704 that the primary position data and primary time data are acquired from the satellite device, the primary data may be displayed 714. However, if it is determined 704 that the primary data is not acquired from the satellite device, secondary position data and secondary time data may be accessed 706 from a mobile device. In one configuration, the secondary position data and secondary time data are accessed 706 over a short-range data link.

In one configuration, the secondary data may be displayed 708. In one aspect, an acquisition of primary data from the satellite device is again attempted 710. A second determination 712 may be made as to whether the primary position data and the primary time data are acquired from the satellite device. If it is determined 712 that the primary data is not acquired from the satellite device, the method 700 may return to continue to attempt 710 to acquire the primary data from the satellite device. However, if it is determined 712 that the primary position data and the primary time data are acquired from the satellite device, the primary data may be displayed 714.

In one example, the method 700 may allow a navigation unit 104 to display secondary position data and secondary time data received from a mobile device over a short-range data link when the navigation unit 104 is unable to receive primary position data and primary time data from a satellite device. The navigation unit 104 may be in a location, such as a canyon, building, etc., that prevents the navigation unit 104 from receiving the primary data from the satellite device. The secondary data may be displayed to a user until the navigation unit is able to establish a connection with a satellite device and receive the primary data.

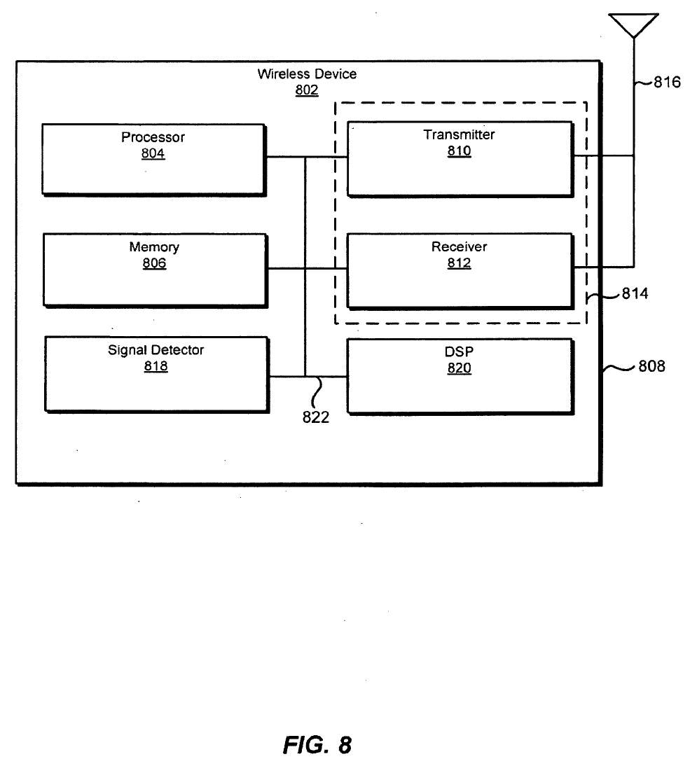

FIG. 8 illustrates various components that may be used in a wireless device 802. The wireless device 802 is an example of a device that may be configured to implement the various methods described herein. The wireless device 802 may be a mobile station 102 or a navigation unit 104.

The wireless device 802 may include a processor 804 which controls operation of the wireless device 802. The processor 804 may also be referred to as a central processing unit (CPU). Memory 806, which may include both read-only memory (ROM) and random access memory (RAM), provides instructions and data to the processor 804. A portion of the memory 806 may also include non-volatile random access memory (NVRAM). The processor 804 typically performs logical and arithmetic operations based on program instructions stored within the memory 806. The instructions in the memory 806 may be executable to implement the methods described herein.

The wireless device 802 may also include a housing 808 that may include a transmitter 810 and a receiver 812 to allow transmission and reception of data between the wireless device 802 and a remote location. The transmitter 810 and receiver 812 may be combined into a transceiver 814. An antenna 816 may be attached to the housing 808 and electrically coupled to the transceiver 814. The wireless device 802 may also include (not shown) multiple transmitters, multiple receivers, multiple transceivers and/or multiple antenna.

The wireless device 802 may also include a signal detector 818 that may be used to detect and quantify the level of signals received by the transceiver 814. The signal detector 818 may detect such signals as total energy, pilot energy per pseudonoise (PN) chips, power spectral density, and other signals. The wireless device 802 may also include a digital signal processor (DSP) 820 for use in processing signals.

The various components of the wireless device 802 may be coupled together by a bus system 822 which may include a power bus, a control signal bus, and a status signal bus in addition to a data bus. However, for the sake of clarity, the various busses are illustrated in FIG. 8 as the bus system 822.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the configurations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the configurations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the configurations disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station and/or a navigation unit. In the alternative, the processor and the storage medium may reside as discrete components in a mobile station and/or a navigation unit.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The previous description of the disclosed configurations is provided to enable any person skilled in the art to make or use the present invention. Various modifications to these configurations will be readily apparent to those skilled in the art, and the generic principles defined herein may be applied to other configurations without departing from the spirit or scope of the invention. Thus, the present invention is not intended to be limited to the configurations shown herein but is to be accorded the widest scope consistent with the principles and novel features disclosed herein.

What is claimed is:

1. A method for accessing data from a secondary device to enhance position data of a navigation unit, the method comprising:
establishing a short-range data link between a navigation unit and a secondary device;
receiving secondary time data from the secondary device over the short-range data link; and
receiving secondary position data from the secondary device over the short-range data link.

2. The method of claim 1, further comprising establishing a connection with a satellite network using the received secondary time data.

3. The method of claim 1, further comprising calculating primary position data using the secondary time data and the secondary position data.

4. The method of claim 3, further comprising displaying the primary position data.

5. The method of claim 3, further comprising displaying the secondary position data until the primary position data is calculated.

6. The method of claim 1, wherein the short-range data link comprises a Bluetooth data link.

7. The method of claim 1, wherein the secondary time data is associated with a cellular network.

8. The method of claim 1, wherein the secondary device is a mobile communications device.

9. The method of claim 8, wherein the mobile communication device is a cellular telephone.

10. The method of claim 1, wherein the navigation unit communicates with a Satellite Positioning System (SPS) selected from the group of SPSs consisting of: a Global Positioning System (GPS), a Global Navigation Satellite System (GNSS), Galileo Positioning System, a Glonass Positioning System, Compass/Beidou Positioning System, and a QZSS Positioning System.

11. The method of claim 1, wherein the short-range data link comprises a low power radio frequency data link selected from the group of low power radio frequency data links consisting of: a Zigbee data link, an Ultra Wide Band data link, and an Infrared Data Association (IRDA) data link.

12. The method of claim 1, wherein the short-range data link is implemented by a Universal Serial Bus (USB) connection between the navigation unit and the secondary device.

13. The method of claim 1, wherein the secondary position data comprises a geographic area in which the secondary device is located.

14. The method of claim 1, wherein the primary position data comprises Global Positioning System (GPS) coordinates indicating the longitudinal and latitudinal coordinates of the navigation unit.

15. A navigation unit configured to access data from a secondary device to enhance position data of the navigation unit, the navigation unit comprising:
a receiver configured to establish a short-range data link with a secondary device;
the receiver further configured to receive secondary time data from the secondary device over a short-range data link; and
the receiver further configured to receive secondary position data from the secondary device over the short-range data link.

16. The navigation unit of claim 15, further comprising a signal acquisition module configured to establish a connection with a satellite network using the received secondary time data.

17. The navigation unit of claim 15, further comprising a position data analyzer configured to calculate primary position data using the secondary time data and the secondary position data.

18. The navigation unit of claim 17, further comprising a display configured to display the secondary position data until the primary position data is calculated.

19. The navigation unit of claim 15, wherein the short-range data link comprises a low power radio frequency data link selected from the group of low power radio frequency data links consisting of: a Bluetooth data link, a Zigbee data link, an Ultra Wide Band data link, and an Infrared Data Association (IRDA) data link.

20. The navigation unit of claim 15, wherein the time data is associated with a cellular network.

21. The navigation unit of claim 15, wherein the secondary device is a mobile communications device.

22. The navigation unit of claim 15, wherein the receiver is further configured to communicate with a Satellite Positioning System (SPS) selected from the group of SPSs consisting of: a Global Positioning System (GPS), a Global Navigation Satellite System (GNSS), Galileo Positioning System, a Glonass Positioning System, Compass/Beidou Positioning System, and a QZSS Positioning System.

23. The navigation unit of claim 15, wherein the secondary position data comprises a geographical area in which the secondary device is located.

24. The navigation unit of claim 15, wherein the primary position data comprises Global Positioning System (GPS) coordinates indicating the longitudinal and latitudinal coordinates of the navigation unit.

25. An apparatus that is configured to access data from a secondary device to enhance position data of the apparatus, the apparatus comprising:
means for establishing a short-range data link with a secondary device;
means for receiving secondary time data from the secondary device over the short-range data link; and
means for receiving secondary position data from the secondary device over the short-range data link.

26. The apparatus of claim 25, further comprising means for establishing a connection with a satellite network using the received secondary time data.

27. The apparatus of claim 25, further comprising means for calculating primary position data using the secondary time data and the secondary position data.

28. The apparatus of claim 27, further comprising means for displaying the secondary position data until the primary position data is calculated.

29. The apparatus of claim 25, wherein the short-range data link comprises a low power radio frequency data link selected from the group of low power radio frequency data links consisting of: a Bluetooth data link, a Zigbee data link, an Ultra Wide Band data link, and an Infrared Data Association (IRDA) data link Bluetooth data link.

30. A computer-program product for accessing data from a secondary device to enhance position data of a navigation unit, the computer-program product comprising a computer readable medium having instructions thereon, the instructions comprising:
code for establishing a short-range data link with a secondary device;
code for receiving secondary time data from the secondary device over the short-range data link; and
code for receiving secondary position data from the secondary device over the short-range data link.
